(19) United States
(12) Patent Application Publication
(10) Pub. No.: US 2008/0069964 A1
(43) Pub. Date: Mar. 20, 2008

(54) Transparent Coating Composition and Method for the Production Thereof and Correspondingly Transparent-Coated Substrates

(76) Inventors: Pelagie Declerck, Reichenberg (DE); Birke Olsowski, Veitshoechheim (DE); Ruth Houbertz-Krauss, Werneck (DE); Michael Popall, Wuerzburg (DE)

Correspondence Address: JACOBSON HOLMAN PLLC, 400 SEVENTH STREET N.W., SUITE 600, WASHINGTON, DC, 20004, US

(21) Appl. No.: 11/663,726

(22) PCT Filed: Sep. 26, 2005
(86) PCT No.: PCT/EP05/10386

§ 371 Date: Oct. 10, 2007

(30) Foreign Application Priority Data
Sep. 24, 2004 (DE) 10 2004 046 406.5

(51) Int. Cl. B05D 1/02; B05D 1/18; C08G 79/00

(52) U.S. Cl. 427/387; 524/588; 528/25; 528/9

(57) ABSTRACT

The invention relates to a method for the production of a transparent coating composition which is based essentially on a polycondensation reaction. The coating composition produced by this method is based on a completely through-condensed inorganic silicate network whilst the organic network is not yet formed. The invention also relates to a method for coating substrates with coating compositions of this type with formation of a coated substrate in which, in addition to the inorganic network, the organic network is also formed by the curing process. Coating compositions of this type and coated substrates are used widely in all optical fields of application.

The invention relates to a method for the production of a transparent coating composition which is based essentially on a polycondensation reaction. The coating compositions produced by this method are based on a completely through-condensed inorganic silicate network, whilst the organic network is not yet formed. The invention also relates to a method for coating substrates with coating compositions of this type with formation of a coated substrate in which, in addition to the inorganic network, the organic network is also formed by the curing process. Coating compositions of this type and coated substrates are used widely in all optical fields of application.

For many optical applications, transparent materials with a high refractive index are required. Silicate compounds SiO₂ do in fact have good optical properties but as a rule have low flexibility and high brittleness. In addition, they demand high temperature conditions during production. For pattern production, e.g. by etching processes with reactive gases, normally more than two method steps are required, which in turn leads to high process costs. It is a further disadvantage with respect to the optical properties that amorphous silicon has a refractive index of no more than 1.46, whereas crystalline silicon can have a refractive index of 1.55.

Organic polymers with a high refractive index appear to overcome the above-described disadvantages. However, organic polymers for optical applications, such as e.g. polymethyl methacrylate (PMMA) which is used in optical plastic fibres, has a low thermal stability (T_{g} of 85 to 105° C.), a refractive index of approx. 1.49 and relatively low chemical resistance. U.S. Pat. No. 4,644,025 provides polymers comprising allyl- and methacryl compounds of benzoic acid derivatives substituted with iodine. A high refractive index is hereby achieved by the presence of compounds which are substituted with iodine. The highest refractive index achieved is 1.62. From U.S. Pat. No. 4,975,223, a method for the production of a transparent polymer with a refractive index between 1.6 and 1.62 is known. A substantial disadvantage of this material is that it is formed from aromatic monomers substituted with halogen, which are problematic from an environmental point of view.

In order to combine the advantageous properties of inorganic and organic materials, various synthesis strategies for the production of inorganic and organic materials have been described. Incorporation of particles in organic/inorganic matrices in two- or multiple-stage syntheses represents here the most common method for increasing the refractive index. According to U.S. Pat. No. 6,656,990, nanoparticles comprising metal oxides (<75 nm) are condensed with organometallic coupling reagents, the organometallic coupling reagent having functionalities which increase the refractive index of the resin. The refractive index of resin is indicated as 1.79 (at 633 nm). However, the materials described here have bromine or iodine compounds which as known increase the refractive index. In addition, it is reported here that the synthesis of oxide nanoparticles is implemented fundamentally in aqueous or alcoholic media, as a result of which adsorption of OH groups on the surface of the nanoparticles takes place. This leads to strong adsorption at approx. 1550 nm. A further method described in this publication is based on dissolving metal oxide powder in a solvent and then incorporating it into the silicate network. In this context, it is however reported that this leads to agglomerated nanoparticles.

As a further synthesis strategy, it is known to combine, in a single-stage reaction, an organic siloxane network with an inorganic matrix by hydrolysis and polycondensation between the organic siloxane network and the metallic precursor. Thus U.S. Pat. No. 6,482,525 describes the bonding of an organic siloxane network to hydrolysable metal compounds, such as e.g. boehmite, in order to increase the abrasion resistance of PMMA surfaces.

In U.S. Pat. No. 6,162,853, a single-stage synthesis method and condensation reactions of metal oxide nanoparticles with an organic silicate network are compared. It is reported here that, by using nanoparticles, a higher refractive index of 1.5435 can be achieved.

Polycondensation reactions between an epoxy silane and silicon-, aluminium- or titanium alkoxides are known from H. Schmidt and B. Seiferling, Mater. Res. Soc. Symp. 73, 739 (1986). The refractive index is investigated here as a function of the metal oxide content and it is established that the refractive index increases with an increasing metal oxide content. At the same time, it is established here that, with respect to the corresponding inorganic systems, the refractive index is surprisingly low. The highest refractive index described here is thereby smaller than 1.55. If the epoxy silane is replaced completely with diphenylsilanediol, the refractive index can be increased to 1.68, however then the resin no longer contains groups which can be polymerised with UV light. On the other hand, even also with the smallest quantities of epoxy silane, a maximum refractive index below 1.6 is obtained.

Starting herefrom, it was the object of the present invention to overcome the disadvantages known from prior art and to provide a method which is easy to manage, with which coatings with higher refractive indices are made possible at the same time as high chemical resistance and mechanical and thermal stability.

This object is achieved by the method having the features of claim 1, the transparent coating composition having the features of claim 12, the method for coating a substrate having the features of claim 16 and the transparent coated substrate having the features of claim 20. The further dependent claims reveal advantageous developments.

According to the invention, a method is provided for the production of a transparent coating composition by means of a polycondensation. The procedure hereby starts with
a) at least one hydrolysable and/or condensable silane which is suitable for forming an inorganic network and has at least one thermally and/or photochemically cross-linkable functional group for forming an organic network, and
b) at least one metal compound of the general formula I
   MXₚ I
with M selected from the group comprising elements of the groups Ib to VIIIb of the periodic table, X being a corresponding counterion for charge compensation or a ligand and p=2 to 4, in an organic solvent, if necessary in the presence of a catalyst,
the condensation being implemented at a temperature between 20 and 80° C. over a reaction time of 24 to 144 h and temperature and reaction time being coordinated to each other such that cross-linking of the functional groups and hence the formation of an organic network is prevented.

The coating composition is synthesised by a catalytically controlled polycondensation. Alternatively a hydrolysis can also precede the polycondensation. For this purpose, preferably a stoichiometric quantity of water is then added in order to hydrolyse the precursors partially.

Preferably, an organometallic compound is used, in particular an organosiloxane which has UV light and/or thermally curable groups. There are included herein preferably acrylates, methacrylates, alkenes, styryl, vinyl and epoxy groups. Via these groups, the organically cross-linkable function is then incorporated into the inorganic network. The organometallic compound is condensed to form a metallic precursor, the metal being selected from the groups Ib to VIIIb of the periodic table.

A catalyst is used preferably in order to control and accelerate the polycondensation reaction. Particularly good results are achieved if barium hydroxide, amines, hydrochloric acid, acetic acid and/or tetrabutylammonium fluoride (TBAF) is used as catalyst.

As silane, preferably a compound of the general formula II is used
RₙSiX₍₄₋ₙ₎

in which the radicals are the same or different and have the following meaning:

R=alkyl, alkenyl, alkinyl, aryl, arylalkyl, alkylaryl, arylalkenyl, alkenylaryl, arylalkinyl or alkinylaryl, these radicals being able to be interrupted by O and/or by S atoms and/or by the group —NR″ and carrying one or more substituents from the group comprising, if necessary substituted, amino, amide, aldehyde, keto, alkylcarbonyl, carboxy, mercapto, cyano, hydroxy, alkoxy, alkoxycarbonyl, sulphonic acid, phosphorus acid, (meth)acryloxy, epoxy or vinyl groups;

X=hydrogen, halogen, alkoxy, acyloxy, alkylcarbonyl, alkoxycarbonyl or —NR″₂, with R″ the same as hydrogen and/or alkyl and

n=1, 2 or 3.

It is particularly preferred that a modified or unmodified styrylsilane, in particular a styrylethyltrimethoxysilane is used as silane.

For the metal compound, the metal M is preferably selected from the group comprising titanium, zirconium, zinc, iron, cobalt, nickel and the lanthanoides.

As organic solvent, preferably ketones, esters, aromatic solvents, cyclic or non-cyclic ethers, alcohols and also protic or aprotic solvents are used.

Preferably in addition at least one solvent is added to the coating composition. As solvent, in particular cyclopentanone, propylacetate, 2-butanone and ethanol are hereby used.

Furthermore, in a preferred embodiment variant of the method according to the invention of the coating composition, an initiator and/or curing agent is added, which initiates the formation of the organic network. These additives can be added before, during as well as after the actual polycondensation reaction.

Furthermore, preferably wetting agents or even other additives are added to the coating composition.

According to the invention, also a transparent coating composition with a refractive index of 1.35 to 1.9 is provided, which can be produced according to the method according to one of the claims 1 to 11.

Coating compositions with a refractive index in the range of 1.53 to 1.59 are hereby particularly preferred.

The coating composition according to the invention can, in a preferred embodiment, have essentially no OH bands in the IR spectrum and is hence essentially free of OH groups.

Preferably the coating composition has no added nanoparticles. This is particularly surprising since, according to the state of the art, nanoparticles are added in order to obtain increased refractive indices.

According to the invention, likewise a method for coating a substrate with a coating composition as previously described is provided. The coating composition is hereby applied on the substrate and subsequently the coating material is cured.

A flat application method is preferred on the one hand as application method, such as e.g. spin coating, dip coating, doctor blade coating or spraying. On the other hand, preferably also other structuring application methods are applied, such as screen printing, tampon printing, ink jet, offset printing and also gravure printing and relief printing.

The curing is thereby preferably effected thermally and/or photochemically.

As substrate, preferably materials from the group comprising metals, semiconductors, substrates with oxidic surfaces, glasses, films, printed circuit boards (PCB), polymers, heterostructures, paper, textiles and/or composites thereof are used.

According to the invention, likewise a transparent coated substrate which can be produced according to the method according to one of the claims 12 to 19 is provided.

Preferably the coating of these substrates has a refractive index of at least 1.62 to 2.75, particularly preferred a refractive index of at least 1.7 to 2.1.

The objects according to the invention are used in every type of optical microsystems, in particular gratings, lenses, coatings, photonic crystals or other photonic structures, multilayers, mirrors, reflective layers, layers in multilayer constructions for antireflective layers and filters, planar architectonic applications and also reflective and antireflective spectacle lens coatings. Likewise photocatalysis and photovoltaics are a suitable application field.

The subject according to the invention is intended to be explained in more detail with reference to the subsequent examples and Figures, without restricting said subject to the embodiments illustrated here.

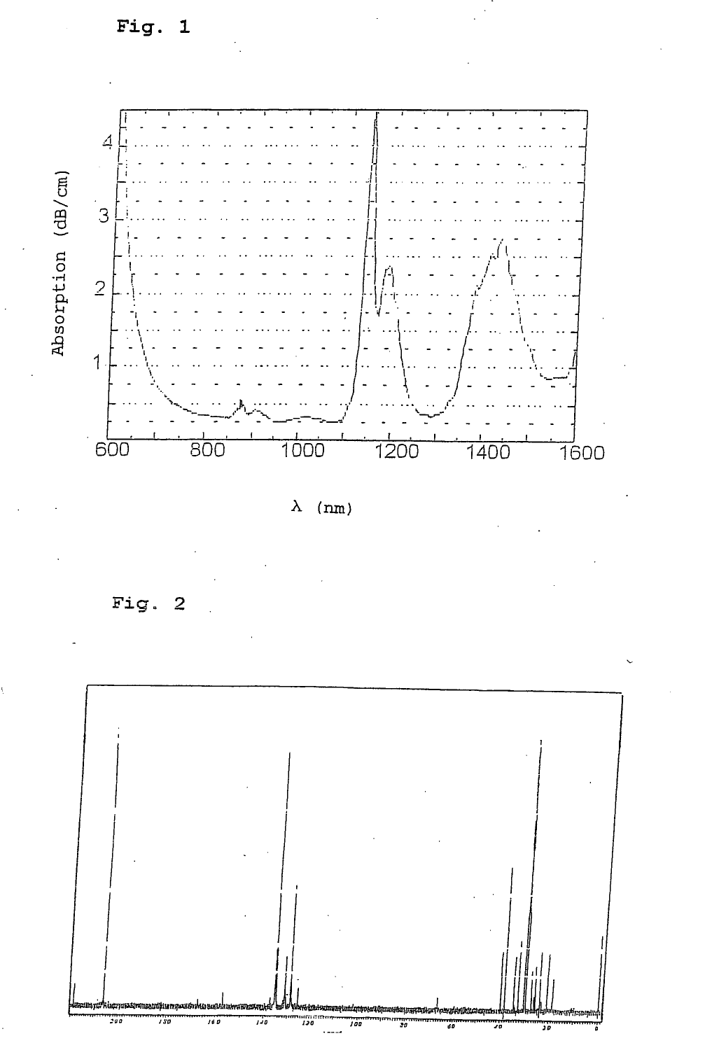

FIG. 1 shows an IR spectrum of a coating composition according to the invention, produced according to example 1.

FIG. 2 shows the ¹³C-NMR spectrum of a coating composition according to the invention according to example 1.

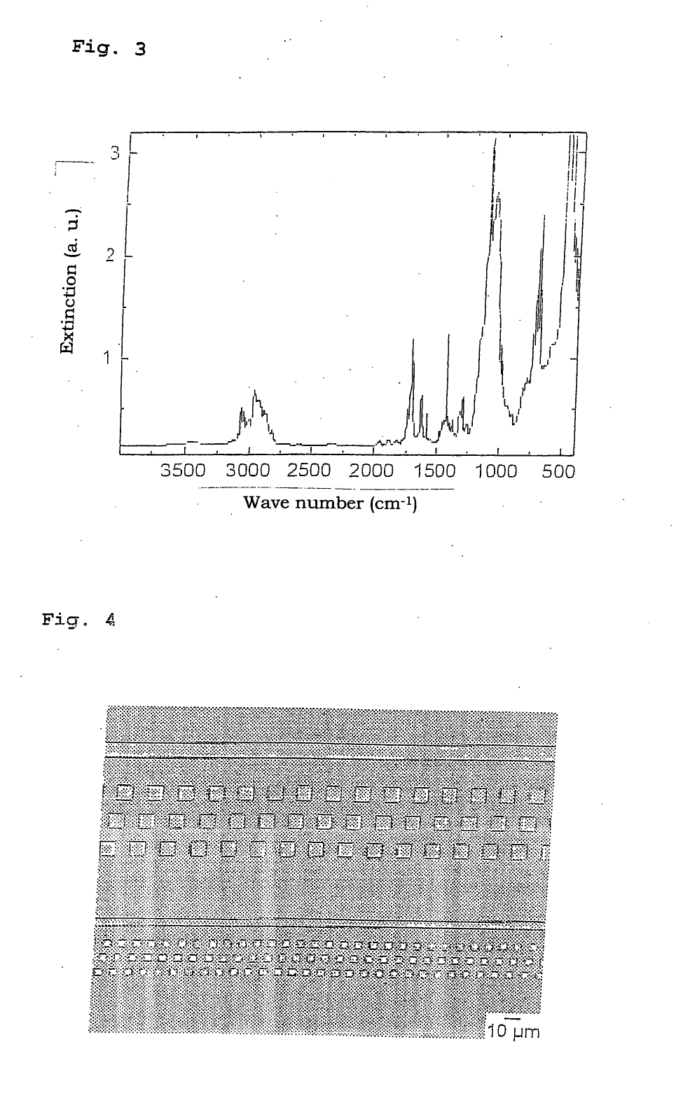

FIG. 3 shows an absorption spectrum of a coating composition according to the invention according to example 1.

FIG. 4 shows a high-resolution microscopic picture of a coating according to the invention, as it was produced in example 1.

FIG. 5 shows a transmission spectrum of a coating according to the invention, as it was produced in example 1.

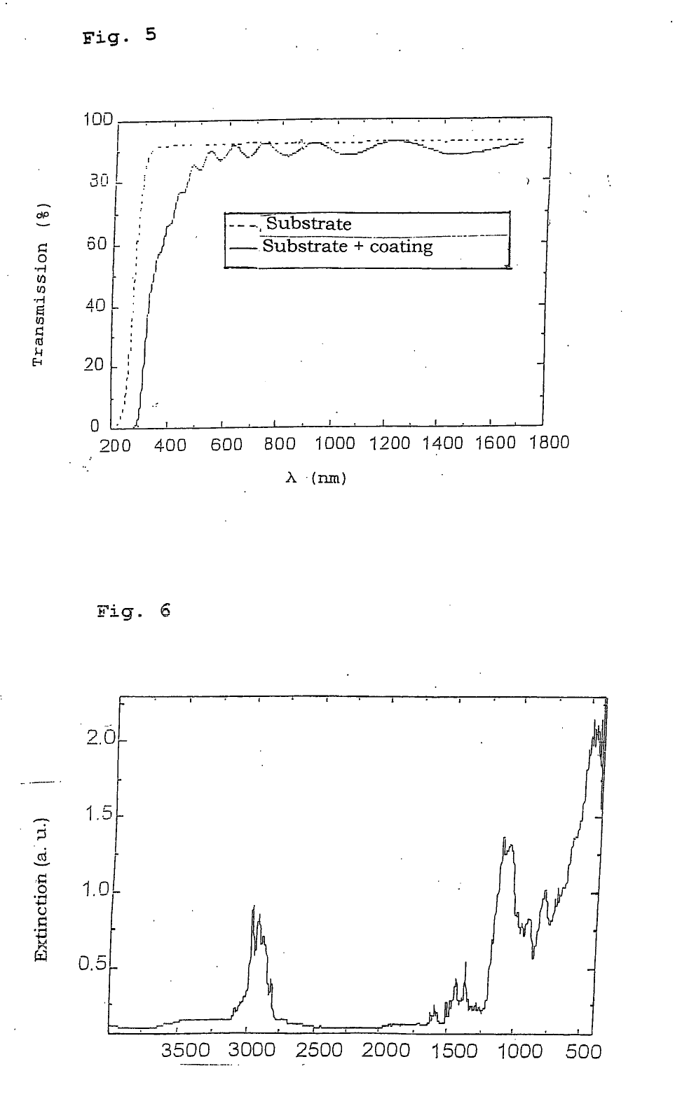

FIG. 6 shows an IR spectrum of a composition according to the invention, as it was produced in example 2.

FIG. 7 shows an absorption spectrum of a coating composition according to the invention according to example 2.

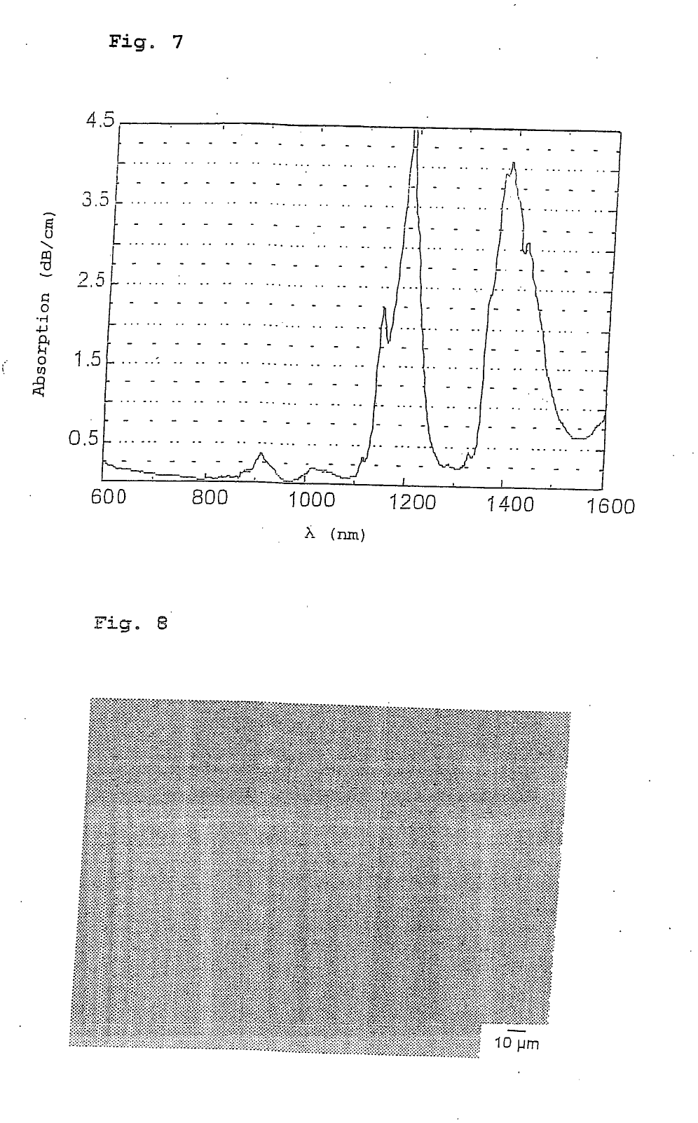

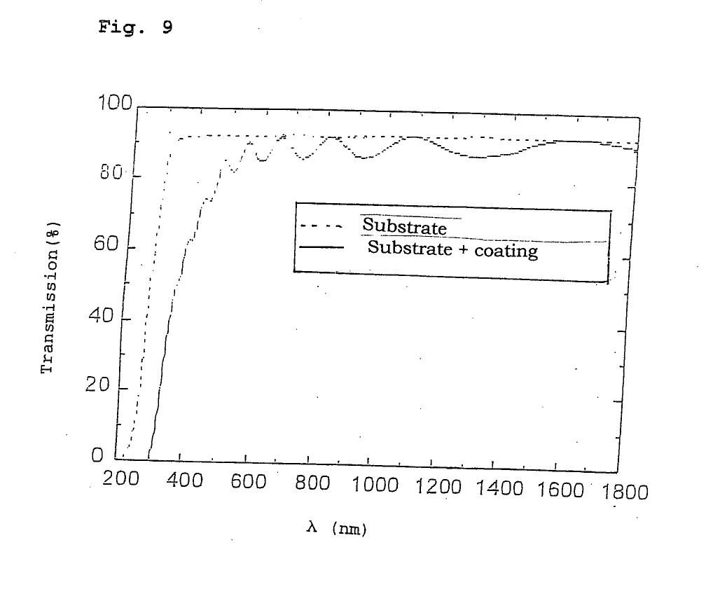

FIG. 8 shows a high-resolution microscopic picture of a coating produced according to example 2.

FIG. 9 shows a transmission spectrum of a coating produced according to example 2.

### EXAMPLE 1

1. Production of the Resin

0.0625 mol diphenylsilanediol and 0.02125 mol 3-methacryloxypropyltrimethoxysilane are added to 0.3447 mol cyclopentanone. 0.125 mol tetrabutylammonium fluoride are used as catalyst. The mixture is agitated for 4 hours, subsequently 0.045 mol titanium ethoxide are added. After two days an orange-coloured and clear solution is obtained. The solvent is removed by means of a rotational evaporator with subsequent draining under vacuum. A dark orange-coloured resin is obtained.

2. Characterisation of the Resin

In FIG. 1, the IR spectrum of the resin is illustrated. This shows no oscillation bands at 3600 cm⁻¹, which corresponds to those of the OH groups. This means that, in the resin, virtually no OH groups are contained. The ²⁹Si-NMR spectrum of the resin shows that the diphenylsilanediol and the 3-methacryloxypropyltrimethoxysilane are contained in the resin as reacted products. The refractive index of the resin at 25° C. is 1.5922, a small quantity of solvent being contained in the resin.

FIG. 2 shows a ¹³C-NMR spectrum, in which cyclopentanone could be detected in the resin (three peaks at d=22.9, 38.3 and 167.0 ppm). This could be attributed to the fact that the solvent was not completely removed by the rotational evaporator. With FT-IR measurement, an oscillation band at 1745 cm⁻¹ could also be detected, which can be attributed to the C═O bond of the cyclopentanone. On the other hand, the ¹³C-NMR spectrum shows seven new peaks with the same intensity. The ¹³C-DEPT (distortion enhancement by polarisation transfer) method was implemented for assignment of the peaks. This spectrum shows six peaks which correspond to the CH₂ groups (d=20.6, 25.7, 27.4, 32.7, 34.3 and 39.9 ppm), whereas the remaining peak which cannot be detected with DEPT is regarded as quaternary carbon (d=157.2 ppm). It can be concluded from the NMR spectrum that a titanium-induced reaction of the cyclopentanone has taken place. Thus no peaks could be determined for the original titanium ethoxide at d=19.4 ppm for CH₃ and at d=70.6 ppm for CH₂. It can be concluded herefrom that the titanium has also reacted and was incorporated in the resin in reacted form. The ¹³C-NMR spectrum shows the absence of Si—OCH₃ of methacryloxypropyltrimethoxysilane (MEMO) (at d=50.9 ppm), which means that MEMO is contained in the resin as completely reacted compound.

An absorption spectrum of the resin is shown in FIG. 3. The absorption in the datacom range (at 830 nm) is approx. 0.3 dB/cm and in the telecom range approx. 0.36 dB/cm (at 1310 nm) or approx. 0.87 dB/cm (at 1550 nm). The SAXS measurement of the resin shows the presence of very small inorganic oxidic units of 2 nm size. Gel permeation chromatography gave the result that the molecular weight is below 750 g/mol (standard: polystyrene).

3. Coating and Pattern Production

The resin is diluted with a suitable solvent such as propylacetate with the addition of a UV initiator, such as, e.g. Irgacure 369. In order to achieve the highest possible optical quality, the material is filtered through a filter with 0.2 μm pore size. The coating is effected by spin coating. Subsequently, the coating is subjected to UV light using an exposure mechanism (mask aligner). After the development step, the sample is finally thermally cured.

4. Characterisation of the Coating

A microscopic picture which shows high-resolution structures is illustrated in FIG. 4. The refractive index of the coating is between 1.64 and 1.65 for the wavelengths between 1448 and 812 nm. It can be detected in FIG. 5 that the transmission of the layer for wavelengths>500 nm is very high.

### EXAMPLE 2

1. Synthesis of the Resin

0.0201 mol styrylethyltrimethoxysilane and 0.0402 mol titanium ethoxide are mixed with 1.08 g HCl (37%). The white mixture is agitated for 1 hour, subsequently a treatment at 65° C. under reflux for a duration of 24 hours provides a transparent yellowish solution. The solvents formed during condensation are removed by means of a rotational evaporator and subsequent draining under vacuum. A transparent yellowish resin is obtained.

2.

The water content measured by Karl Fischer titration is less then 0.03%. The IR spectrum of the resin is illustrated in FIG. 6, which shows no significant oscillation bands at 3600 cm⁻¹, which by means of the IR spectrum leads to the conclusion of virtually no OH groups. The ²⁹Si-MNR spectrum of the resin shows that the styrylethyltrimethoxysilane is contained in the resin as reacted product. The refractive index of the resin at 25° C. is 1.5979. The absorption spectrum is illustrated in FIG. 7. An absorption in the datacom range (at 830 nm) of approx. 0.06 dB/cm is shown and in the telecom range of approx. 0.22 dB/cm (at 1310 nm) or 0.63 dB/cm (at 1550 nm).

3. Coating and Pattern Production

The resin is diluted in a suitable solvent such as propylacetate and a UV initiator is added (Irgacure 369). In order to achieve the highest possible optical quality, the material is filtered through a filter with a 0.2 μm pore size. The coating is implemented by spin coating. Subsequently, the coating is subjected to UV light in a mask. After the development step, the sample is finally thermally cured.

4. Characterisation of the Coating

A microscopic picture of the coating is illustrated in FIG. 8. This shows high-resolution structures. The refractive index of the coating at 1150 nm is between 1.67 and 1.70 (for the wavelengths between 1286 and 926 nm). The transmission spectrum of the coating, shown in FIG. 9, shows very high transmissions for wavelengths>500 nm.

1. Method for the production of a transparent coating composition by means of a polycondensation of
a) at least one hydrolysable and/or condensable silane which is suitable for forming an inorganic network and has at least one thermally and/or photochemically cross-linkable functional group for forming an organic network, and
b) at least one metal compound of the general formula I
MXp I
with M selected from the group comprising elements of the groups Ib to VIIIb of the periodic table, X being a corresponding counterion for charge compensation or a ligand and p=2 to 4,
in an organic solvent, if necessary in the presence of a catalyst,
the condensation being implemented at a temperature between 20 and 80° C. over a reaction time of 24 to 144 h and temperature and reaction time being coordinated to each other such that cross-linking of the functional groups and hence the formation of an organic network is prevented.

2. Method according to claim 1,
characterised in that the silane has the general formula I
RnSiX₍₄₋ₙ₎
in which the radicals are the same or different and have the following meaning:
R=alkyl, alkenyl, alkinyl, aryl, arylalkyl, alkylaryl, arylalkenyl, alkenylaryl, arylalkinyl or alkinylaryl, these radicals being able to be interrupted by O and/or by S atoms and/or by the group —NR″ and carrying one or more substituents from the group comprising, if necessary substituted, amino, amide, aldehyde, keto, alkylcarbonyl, carboxy, mercapto, cyano, hydroxy, alkoxy, alkoxycarbonyl, sulphonic acid, phosphorus acid, (meth)acryloxy, epoxy or vinyl groups;
X=hydrogen, halogen, alkoxy, acyloxy, alkylcarbonyl, alkoxycarbonyl or —NR″₂, with R″ the same as hydrogen and/or alkyl;
n=1, 2 or 3.

3. Method according to one of the preceding claims,
characterised in that the silane is a modified or unmodified styrylsilane, in particular a styrlethyltrimethoxysilane.

4. Method according to one of the preceding claims,
characterised in that M is selected from the group comprising titanium, zirconium, zinc, iron, cobalt, nickel and the lanthanoides.

5. Method according to one of the preceding claims,
characterised in that the organic solvent is selected from the group comprising ketones, esters, aromatic solvents, cyclic or non-cyclic ethers, alcohols and also protic or aprotic solvents.

6. Method according to one of the preceding claims,
characterised in that acidic, basic and/or nucleophilic catalysts, in particular barium hydroxide, amines, hydrochloric acid, acetic acid and/or tetrabutylammonium fluoride (TBAF) are used as catalyst.

7. Method according to one of the preceding claims,
characterised in that, before the condensation, a hydrolysis of the silanes is implemented.

8. Method according to one of the preceding claims,
characterised in that the quantity of water used for the hydrolysis is introduced by means of moisture-laden adsorbents, aqueous organic solvents, salt hydrates or water-forming systems.

9. Method according to one of the preceding claims,
characterised in that in addition at least one solvent is added to the coating composition.

10. Method according to one of the preceding claims,
characterised in that in addition at least one initiator and/or curing agent is added to the coating composition.

11. Method according to one of the preceding claims,
characterised in that at least one wetting agent or another additive is added to the coating composition.

12. Transparent coating composition which has a refractive index of 1.35 to 1.95 and can be produced according to the method according to one of the claims 1 to 11.

13. Coating composition according to claim 12,
characterised in that the coating composition has a refractive index of 1.53 to 1.59.

14. Coating composition according to one of the claims 12 or 13,
characterised in that the coating composition displays essentially no OH bands in the IR spectrum and hence is free of OH groups.

15. Coating composition according to one of the claims 12 to 14,
characterised in that the coating composition is free of added nanoparticles.

16. Method for coating a substrate with a coating composition according to one of the claims 12 to 15, in which the coating composition is applied on the substrate and subsequently the coating composition is cured.

17. Method according to claim 16,
characterised in that the coating material is applied by flat application methods, in particular spin coating, dip coating, doctor blade coating or spraying, or by structuring application methods, in particular screen printing, tampon printing, ink jet, offset printing and also gravure printing and relief printing.

18. Method according to one of the claims 16 or 17,
characterised in that the curing is effected thermally and/or photochemically.

19. Method according to one of the claims 16 to 18,
characterised in that the photochemical curing is effected by single or multiphoton processes.

20. Method according to one of the claims 16 to 19,
characterised in that the substrate is selected from the group comprising metals, semiconductors, substrates with oxidic surfaces, glasses, films, printed circuit boards (PCB), polymers, heterostructures, paper, textiles and/or composites thereof.

21. Transparent coated substrate which can be produced according to the method according to one of the claims 12 to 20.

22. Substrate according to claim 21,
characterised in that the coating has a refractive index of at least 1.62.

23. Substrate according to one of the claims 21 or 22,
characterised in that the coating has a refractive index of at least 1.7.
